(19) United States
(12) Patent Application Publication
(10) Pub. No.: US 2006/0021275 A1
(43) Pub. Date: Feb. 2, 2006

(54) PEST CONTROL METHOD AND APPARATUS THEREFOR

(76) Inventor: Philip Edwin Howse, Hampshire (GB)

Correspondence Address: HARTMAN & HARTMAN, P.C., 552 EAST 700 NORTH, VALPARAISO, IN, 46383, US

(21) Appl. No.: 11/161,699

(22) Filed: Aug. 12, 2005

Related U.S. Application Data
(63) Continuation-in-part of application No. 09/700,863, filed on Nov. 21, 2000.

(51) Int. Cl. A01M 1/20

(52) U.S. Cl. 43/131; 43/107

(57) ABSTRACT

A method and apparatus for controlling a pest by at least partially coating the pest with a particulate material that incorporates a killing or behavior-modifying agent. The method and apparatus involve drawing the pest sufficiently close to a surface bearing the particulate material, which is rendered airborne by movement of the pest in the region of the surface. The particulate material is electrostatically charged when rendered airborne, so as to be electrostatically attracted and attached to the pest.

### CROSS REFERENCE TO RELATED APPLICATIONS

This is a continuation-in-part patent application of co-pending U.S. patent application Ser. No. 09/700,863, filed Nov. 21, 2000, which claims the benefit of International Application No. PCT/GB99/01631, filed May 21, 1999. In addition, this application is related to International Patent Application No. PCT/GB93/01442 (Publication No. W094/00980) to Howse and U.S. Pat. No. 6,041,543 to Howse, the contents of which are incorporated herein by reference.

### BACKGROUND OF THE INVENTION

This invention relates to the control of pests, such as, insect pests, and is especially, but not exclusively, related to the control of flying or crawling insect pests.

The constant pressure of pesticide use in agriculture can lead to the development of pesticide-resistance amongst insect pest species, resulting in the killing of non-target animals including beneficial predators and parasites which tend to maintain a natural balance of the pest species. Also, it leads to the contamination of the environment with consequential harmful effects on human and animal health, resulting from exposure to pesticide residues in water and comestible products.

Therefore, it is desirable to target pest species accurately and to minimize the amount of pesticide which finds its way into the environment and/or onto non-target animals and organisms.

In International Patent Application No. PCT/GB93/01442 (Publication No. W094/00980), there is disclosed means for accurately targeting pest species, such disclosure including a method of luring one sex of an inspect pest species to a bait using that insect pests' sexual pheromone, usually in the form of a volatile attractant, contaminating that insect pest with electrostatically-charged powder or other particulate material formulated with a suitable slow-acting killing agent or behavior-modifying chemical, and allowing the so-contaminated insect pest to contaminate other insect pests of the opposite sex during mating attempts. For this method to operate, it is desirable that as much as possible of the powder or other particulate material is picked up by the target insect pest and not lost into the environment by the action of wind and weather, where it can affect non-target animals or organisms.

### BRIEF SUMMARY OF THE INVENTION

Accordingly, it is an object of the present invention to provide various methods of and means for controlling pests, such as flying or crawling insect pests, which overcome, or at least substantially reduce, the disadvantages associated with the known pest control methods discussed above.

One aspect of the invention provides a method of controlling a pest by at least partially coating the pest with a particulate material incorporating a killing or behavior-modifying agent, which method comprises directing, attracting or otherwise luring the pest onto, above, or otherwise adjacent a surface bearing such a particulate material to render the material airborne by the movement of the pest on, above, or in the region of the particulate material-bearing surface.

The particulate material is preferably a powder which is sufficiently fine for it to be rendered airborne by a pest moving across, flying above or adjacent, or taking-off from the particulate material-bearing surface, so that the pest becomes at least partially coated with the powder. For this purpose, the particulate material is preferably capable of being electrostatically charged, preferably by friction, as it is rendered airborne from the particulate material-bearing surface. In a preferred embodiment, the particulate material is electrostatically charged during deposition on the particulate material-bearing surface so as to electrostatically bond to the particulate material-bearing surface, gradually loses at least some of its charge over time so as to be capable of being readily dislodged from the particulate material-bearing surface due to certain disturbances (e.g., a pest), and then rapidly electrostatically charges when dislodged by such a disturbance so as to electrostatically bond to an adjacent surface, such as the cause of the disturbance (e.g., the pest).

The powder may comprise or be combined with at least one biological, synthetic or natural pesticide as a killing agent.

The particulate material-bearing surface is preferably associated with a trap having an electrically insulating material which may comprise a plastic material.

The inventive method may include providing a pheromone or parapheromone attractant for luring pests to be controlled, and the surface may be coated with a fine powder of the attractant which is charged electrostatically, preferably retaining its electrostatic charge for long periods on the surface.

Any undesired removal or loss of the particulate material from the particulate material-bearing surface may be eliminated or at least substantially reduced, for example, by means of raised edges, preferably rounded, at the periphery of the surface.

Alternatively or additionally, the particulate material can be accommodated in at least one recess or trough associated with the particulate material-bearing surface, preferably in at least one recess provided in the surface. Also, the upper periphery of each recess may be provided with raised edges.

Further, the particulate material-bearing surface may be provided on a plate which is preformed and stands alone, that is, free-standing, preferably upon feet.

Alternatively, the particulate material-bearing surface can comprise at least one trough in which the particulate material is accommodated.

In any event, the dimensions of each recess or trough in which the particulate material is accommodated, are preferably generally smaller than those of the pests to be controlled.

In a preferred embodiment, the particulate material-bearing surface constitutes part of a tubular trap, preferably of triangular cross-section and open-ended, in which case, the particulate material-bearing surface may be an interior surface of the trap of which at least part, and preferably a major proportion, may be coated with the particulate material, such as a fine powder, which, as indicated above, may be electrostatically chargeable, preferably by friction.

A second aspect of the invention resides in a pest control apparatus comprising a surface onto, above, or in the region of which a pest is capable of being directed, attracted, or otherwise lured and which bears a particulate material incorporating a killing or behavior-modifying agent, wherein the particulate material is capable of being rendered airborne by movement of the pest on, above, or in the region of the particulate material-bearing surface.

The particulate material is preferably a powder which is sufficiently fine for it to be rendered airborne by a pest moving across, flying above or in the region of, or taking-off from the particulate material-bearing surface, so that the pest becomes at least partially coated with the powder, which may comprise or be combined with at least one biological, synthetic or natural pesticide as a killing agent.

The particulate material preferably has properties which enable it to be electrostatically charged, preferably by friction, as it is rendered airborne from the particulate material-bearing surface. In a preferred embodiment, particles of the particulate material carry an electrostatic charge, for example, as a result of the process by which the particles were deposited on the particulate material-bearing surface, so as to electrostatically bond to the particulate material-bearing surface. The electrostatic charge of the particles is such that at least some of the particles are capable of being readily dislodged from the particulate material-bearing surface due to certain disturbances (e.g., a pest). The electrostatic charging capability of the particles is such that the particles rapidly electrostatically charge when dislodged by such a disturbance so as to electrostatically bond to an adjacent surface, such as the cause of the disturbance (e.g., the pest).

The surface can be is associated with a trap comprising an electrically insulating material, preferably a plastic material.

The inventive apparatus may also comprise a pheromone or parapheromone attractant. Further, the surface may be coated with a fine powder of the attractant which is electrostatically charged, preferably being capable of retaining its electrostatic charge for long periods on the trap surface.

Any undesired removal or loss of the particulate material from the surface may be eliminated or at least substantially reduced, preferably by raised edges, such as raised and rounded edges, at the periphery of the surface.

In an embodiment of the inventive apparatus, the particulate material is accommodated in at least one recess or trough associated with the particulate material-bearing surface. At least one recess may be provided in the particulate material-bearing surface, in which case, the upper periphery of one or more recesses may have raised edges.

In another embodiment, the particulate material-bearing surface is on a plate which is preformed and stands alone, namely, free standing, preferably upon feet.

Alternatively, the particulate material-bearing surface comprises at least one recess or trough in which the particulate material is accommodated, with the dimensions of each recess or trough preferably being generally smaller than those of the pests to be controlled.

The particulate material-bearing surface may constitute part of a tubular trap, preferably of triangular cross-section and being open-ended optionally, in which case, the surface may be an interior surface of the trap of which at least part, and preferably a major proportion, may be coated with the particulate material which, if a fine powder or otherwise, may be electrostatically charged, preferably by friction.

The electrostatic charge on the powder discharges more rapidly in high humidity environments and, irrespective of climatic conditions, wind blowing through the trap would tend to eventually remove the powder completely therefrom.

Accordingly, it is a further object of the invention to provide a pest control trap wherein such removal or other loss of the particulate material, such as a fine powder, from the particulate material-bearing surface of the trap is eliminated or at least substantially reduced.

Thus, a third aspect of the invention resides in a pest control trap comprising a surface having at least one recess therein, wherein a particulate material incorporating a pest killing or behavior-modifying agent, is accommodated in one or more recesses.

Preferably, each recess, which is preferably discrete, has dimensions which are generally smaller than those of pests to be controlled. Advantageously, the particulate material is capable of being rendered airborne by movement of a pest in the vicinity thereof. Also, the particulate material, such as a fine powder, may be capable of being electrostatically charged, preferably by friction, as it is rendered airborne, for subsequent contamination of a pest in the vicinity thereof.

A fourth aspect of the invention is directed to a method of preventing the dispersion of a pest-contaminating particulate material from a pest trap, which method comprises accommodating the material, such as a fine powder, in at least one recess in a surface of the trap.

Thus, this inventive method protects the pest-contaminating particulate material from wind action and ensures that it can be attached to a pest, such as a flying insect pest, as it flies above or takes-off from the surface. By using the downthrust of air generated by such a pest's wing beats to render the particulate material, such as a fine powder, airborne, it also ensures at the same time that the powder becomes electrostatically charged, so that it will adhere to the pest.

In one embodiment of the invention, and as discussed above, there is provided a plate, preferably made of a plastic material, whose surface has an array of recesses associated therewith, preferably in the form of holes, apertures, cavities or other indentations of smaller diameter than the body length of the target pest.

This plate may be placed in the bottom of a pest monitoring trap, normally, but not necessarily, in a generally horizontal plane in use. The particulate material, preferably in the form of a fine powder and whether it be charged or uncharged, is accommodated in the recess(es) and, in this manner, is protected from the undesirable effects of wind action or other air currents flowing across (i.e., substantially parallel to) the surface of the plate. Also, the trap need contain no sticky materials or other pest-retaining devices, so that pests can enter and leave the inventive trap readily. In one embodiment, the plate may also constitute the base of the trap.

It is well known that when a flying pest, such as a flying insect pest, is airborne, it gains lift by providing downward momentum to the air around it. It can be calculated that a flying insect pest, such as a mosquito weighing about one milligram, can generate a downward air velocity of about 0.5 ms⁻¹, while a larger flying insect pest, such as a large moth weighing about one gram, can generate a downward air velocity of about 1 ms⁻¹. Additionally, it is known that during take-off, flying insect pests can generate extra lift by generating vortices on the downward strokes of their wings, which vortices are then directed downwardly (Kingsolver, Scientific American 1985).

A flying insect pest which lands on, say, the particulate material-bearing surface of one of the embodiments discussed above, and then takes-off or hovers above it, will displace air downwardly at comparatively high velocity. This is sufficient to render the particulate material, such as a fine powder, on the surface, airborne and as the powder becomes detached from the surface, it can under certain circumstances and preferably does according to the invention, undergo electrostatic charging. The polarity of any such charge will depend upon the nature of the particulate material and of the surface which bears it and, thus, can be adjusted so that it is of opposite polarity to that of the surface of the body of the insect pest. In this way, the movement of a flying insect pest can be used to produce an appropriate electrostatic charge on the particles of particulate material, as well as rendering them airborne. The electrostatically-charged particles of particulate material, such as a fine powder, will tend to settle on the insect pest as a result of being attracted toward the pest from a very short distance.

Thus, it can be seen that the various aspects of the invention provide means for: (1) coating pests, such as insect pests, with a powder whose particles are capable of being rendered airborne by the pests' own movements; (2) reducing loss of powder from a pest control trap or “bait” station by wind or other air currents that enter the trap from the surrounding environment; (3) controlling powder loss by accommodating the powder or other particulate material in recesses associated with a surface of a pest control trap, such recess(es) being smaller in dimension than the pests; (4) controlling, in particular, flying insect pests by coating them with powder or other fine particulate material which is electrostatically charged, for example by friction, as it is rendered airborne by the pests' movements; (5) controlling insect pests, in particular, by using powders of other particulate material incorporating biological, synthetic and/or natural pesticides; and (6) controlling crawling pests, for example, insect pests, by using a particulate material which can be rendered airborne by the pests running across a surface bearing the particulate material.

Other objects and advantages of this invention will be better appreciated from the following detailed description.

### BRIEF DESCRIPTION OF THE DRAWINGS

In order that the various aspects of the invention may be more fully understood, preferred embodiments in accordance with at least some of them will now be described by way of example and with reference to the accompanying drawings in which:

FIG. 1 is a sectional perspective view of one embodiment of pest control trap;

FIGS. 2 and 3 are respective plan and sectional views of a base plate of the trap shown in FIG. 1; and

FIGS. 4 and 5 are respective perspective and side elevational views of another embodiment of pest control trap.

### DETAILED DESCRIPTION OF THE INVENTION

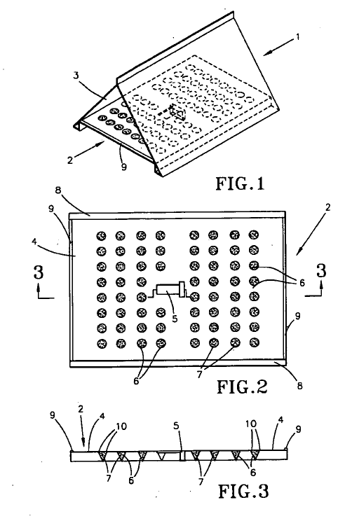

Referring firstly to FIGS. 1 to 3 of the accompanying drawings, an open-ended trap, indicated generally at 1 in FIG. 1, for monitoring flying insect pests, is of generally triangular cross-section and comprises a base plate, indicated generally at 2, which has been placed inside the casing 3 of the open-ended trap 1, to replace the conventional sticky surface which is commonly used in such traps. While a triangular-shaped vertical cross-section is shown for the trap 1, it should be understood that a variety of cross-sectional shapes could be used.

The base plate 2, as shown in FIGS. 2 and 3, defines an upper surface 4 thereof and has a central cavity 5 containing an odor attractant (not shown) of suitable formulation, for example, a semiochemical, such as a pheromone or a parapheromone, for attracting flying insect pests into the trap where they can land on and take-off from the upper surface 4 of the plate 2.

The surface 4 of the base plate 2 is shown as provided with a regular array of circularly cross-sectioned, downwardly-tapering recesses 6 in which is accommodated a particulate material in the form of a fine powder, as shown at 7 in FIG. 3, which incorporates a pest-killing or behavior-modifying agent and which is sufficiently fine for it to be capable of being rendered airborne by the movement of the pests, for example, the wing beats thereof, on, above, or in the region of the powder-bearing surface 4. In this manner, the powder 7 is capable of forming a fine cloud thereof above the surface 4, thereby contaminating the insect pests flying above it and any others flying through the trap 1.

Preferably, the maximum diameter of the recesses 6, namely, that at the open tops thereof, is less than, say, the body lengths of the pests. The recesses 6 are shown as having an approximately V-shaped vertical section, which maximizes the surface area of the powder 7 presented at the surface 4 of the base plate 2 while also minimizing compaction of the powder 7 at the bottom of the recesses 6. The powder 7 may be retained in a plurality of individual recesses 6 as shown, or in grooves in the surface 4 of the plate 2, again preferably approximately V-shaped in cross-section. A preferred total volume of the recesses 6 is determined by the amount of powder 7 with which it is desired to charge the trap 1, and by the surface area of the base plate 2. In practice, the amount of powder 7 utilized is typically about one to about ten grams for a surface area of about 70 to about 400 square centimeters for the plate 2.

As discussed above, the trap 1, or at least its base plate 2 and associated components, may be made of an electrically insulating material, for example, a suitable plastic material. Furthermore, the powder 7 is capable of being electrostatically charged, preferably by friction, as it is rendered airborne by the wing beats or other movements of the flying insect pests in the vicinity thereof. In this way, the electrostatically-charged powder particles adhere to the insect pests, thereby contaminating them and, possibly, allowing them to contaminate other insect pests of the opposite sex during mating attempts. The smallest preferred particle size is about five micrometers average diameter because particles below this size are readily inhaled and may affect the respiratory system of users. The maximum preferred diameter is about 100 micrometers average diameter. Particles above this size have a low surface area to volume ratio and, as result, are believed to fall off an insect too easily because the particle may not carry a sufficient charge on its surface for its weight. Particles within this range are believed to be sufficiently fine to become airborne by the wing beats of flying insect pests approximately the size of a housefly. Preferred materials for the powder 7 include highly electrically-resistive materials such as waxes, especially carnauba wax, but also paraffin waxes, candelilla wax, soy wax, other plant waxes, and beeswax, as well as non-wax materials including plastic polymers, ceramic materials, natural polymers, and cellulosic materials.

The benefit of placing the electrostatically-chargeable powder 7 in the recesses 6 is to reduce the shearing force acting on them from air currents moving across (i.e., substantially parallel to) the surface 4 of the plate 2, and therefore to minimize the possibility of the powder particles being displaced from the recesses 6 by air currents that enter the trap 1 from the environment surrounding the trap. However, it is to be understood that the recesses 6 do not prevent displacement of the powder 7 by air currents with a velocity component normal to the surface 4, as is the case of a flying insect taking-off or hovering above the surface 4, in which case the wing-beats of the flying insect displace air downwardly (toward the surface 4) at sufficiently high velocities (e.g., about 0.5 to about 1 ms⁻¹) to render the particles airborne.

When the recesses 6 are first filled with the powder 7, the electrostatically-chargeable particles of the powder 7 accumulate a surface charge because inherent frictional charging occurs when the particles are deposited in the recesses 6, such as when the particles come into contact with the walls of the device(s) used to deposit the powder 7 in the recesses 6. In consequence, the particles of the powder 7 become electrostatically adhered or bonded to the surfaces of the recesses 6. It is well known that an electrostatic charge is quickly lost from the surface of an electrostatically-charged particle placed on a conducting surface. By forming the base plate 2 of an electrically insulating material, electrostatic discharging of the powder 7 within the recesses 6 is very slow, with the result that the particles of the powder 7 remain electrostatically held within the recesses 6. It is further believed that the powder 7 forms a fine coating having a thickness (depth) of greater than one particle-diameter (i.e., more than a monolayer) on the surfaces of the recesses 6. Over time, the electrostatic charge will tend to distribute itself equally among all the particles that are in contact with each other, with the result that the powder particles are believed to share a substantially uniform charge of the same polarity. Consequently, the particles do not tend to adhere to each other but instead tend to repel each other, and therefore can easily be displaced from each other, particularly those particles that are stacked on top of another particle within a recess 6 and therefore are not electrostatically bonded directly to the surface of the recess 6.

It is also well known that an electrostatic charge can be conducted away (discharged) by water molecules, as is the case of air containing moisture. Therefore, it is believed that after particles of the powder 7 have been deposited in the recesses 6 of the trap 1 in a manner that they have an electrostatic charge, the particles will slowly lose from their surfaces much (though unlikely all) of the charge they had accumulated. The rate at which the particles lose their charge is uncertain, as it will depend at least in part on the moisture content of the air.

Notably, the action of wind on the powder 7 increases the electrostatic charge of the powder particles through the friction engendered by the moving air and by the powder particles moving against each other and against the sides of the recesses 6. If this occurs, the powder particles repel each other more strongly and can therefore be more readily caused to move relative to each other. The trap 1 shown in FIG. 1 is configured to limit the passage of wind therethrough, largely to crosswinds parallel to the surface 4 in which the recesses 6 are formed, and the recesses 6 place the powder 7 beneath the surface 4 and therefore away from such crosswinds, thereby reducing the likelihood of additional charging of the powder particles within the recesses 6 from air movement that originates from outside the trap 1. Nonetheless, all of the powder particles within the recesses 6 (and likely carrying some electrostatic charge), and particularly those particles that do not directly contact the surfaces of the recesses 6, are still capable of being displaced and electrostatically charged (recharged or more likely additionally charged) by the vertical components of air movement generated by the wing-beats of insects that have entered the trap 1 and are hovering over, taking off from, or landing on the surface 4. The result is the generation of a cloud of like-charged powder particles that repel each other and are attracted to the nearest solid object, such as the insect that caused the air disturbance.

Various modifications can be incorporated into the pest monitoring trap 1, for example, to reduce loss of the powder 7 by wind action or other air currents blowing through it. Such modifications may include raised edges 9 at the periphery of the plate 2, which edges may be rounded to reduce turbulence being generated over the plate 2. Additionally or alternatively, the recesses 6 may be provided with raised edges 10 around their upper peripheries which may also be used for the same purpose.

The plate 2 may be preformed and arrange to stand alone, for example, by means of the feet 8, as shown in FIGS. 2 and 3, or designed to fit into conventional insect traps of various shapes and sizes. Alternatively, the recesses 6 may be formed during the manufacture of the trap 1 in, for example, the base wall of the casing 2.

In the embodiment of pest monitoring trap 1 discussed above with reference to FIGS. 1 to 3, the base plate 2, and hence the powder-bearing surface 4, lies in a generally horizontal plane during use. However, the orientation of the plane of the base plate 2, and hence that of the powder-bearing surface 4, may be vertical or at any suitable angle thereto.

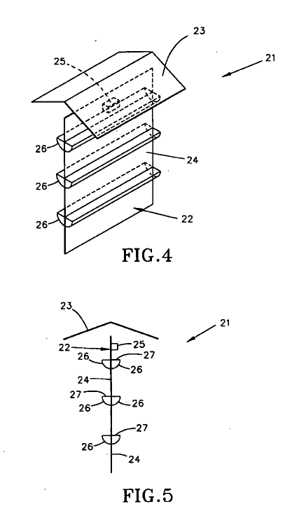

Such a vertical orientation of the plate and associated powder-bearing surface is shown in a second embodiment of a flying insect pest monitoring trap 21 in FIGS. 4 and 5. This vertical orientation of powder-bearing surfaces 24 of a base plate 22 is, in certain circumstances, desirable because some species of flying insect pest, for example, the olive fruit fly, land preferentially on vertical surfaces.

In the second embodiment of the flying insect pest monitoring trap 21 shown in FIGS. 4 and 5, the opposed vertical surfaces 24 of the plate 22 are again provided with recesses, this time in the form of troughs 26, in which is accommodated, once again, a pest-killing or behavior-modifying powder 27 which, as described in reference to the first embodiment, is capable of being rendered airborne and electrostatically charged as a result of the wing beats or other movements of flying insect pests in the region thereof.

The trap 21 is provided with a roof 23 for preventing rainwater from accumulating in the troughs 26, while a source 25 of odor attractant, such as that discussed above in relation to the first embodiment of FIGS. 1 to 3, is provided at the upper region of the plate 22.

Thus, flying insect pests are attracted to the trap 21 by a combination of visual features, including color, and the odor attractant 25, again as in the case of the first embodiment.

The troughs 26 in which the powder 27 is accommodated, may be placed at an angle to their respective surfaces 24, or, as shown in FIGS. 4 and 5, may be in the form of cup or trough-shaped projections, namely, the troughs 26.

The shape of the powder-accommodating recesses 6 of the first embodiment of the trap 1 and the corresponding troughs 26 of the second embodiment of the trap 21 may also be such that any turbulence of air flowing into them is reduced, which might otherwise lead to vortex formation. For example, they may be V-shaped in vertical section, such as the recesses 6 shown in the first embodiment of the trap 1 of FIGS. 1 to 3. Alternatively, the recesses may also consist of channels in the base plate 2 which can be rectilinear, curved, concentric or spiral. The recesses may be discrete, such as those shown at 6 in the first embodiment of the trap the 1 or may be substantially continuous, for example, the effectively powder-bearing surface 4 of the plate 2 of the trap 1 may be corrugated.

By suitable modification, the respective recesses 6 and troughs 26 of the first and second embodiments of the traps 1 and 21 may be rendered suitable for crawling insect pests and, indeed, other walking pests, whereby the pests disturb the particulate material, for example, the powder 7 of the first embodiment, by their movement, such as running, across the surface 4.

The efficiency of the inventive trap and its powder-bearing surface 4 of the plate 2 was demonstrated in the following experiments.

Two plates 2, each 120×180 mm and made of a synthetic plastic polymer (High Impact Polystyrene, or “HIPS”), were placed in a horizontal plane inside respective, separate cages, each 900×550×600 mm, in the laboratory, each cage containing 50 houseflies (Musca domestica L). Each plate 2 had a chemical lure (protein+(Z)-9-tricosene) at its center, for example, in a central cavity 5.

One plate 2, in accordance with the invention, had ninety-six recesses 6, each 6 mm in diameter and 8 mm deep, with generally V-shaped vertical sections, in the surface 4 of the plate 2.

The second plate was of conventional, prior art design, having a smooth surface with no recesses therein. The second plate was covered with a thin layer of carnauba wax powder weighing 0.32 grams. 0.16 grams of the same material was placed in the recesses 6 of inventive plate 2. The particles of both carnauba wax powders were about 5 to about 20 micrometers in diameter, and electrostatically adhered to their respective plates.

After twenty four hours, 52% of the flies in the cage containing the first plate 2 of this invention were contaminated with more than fifty particles of the powder per fly, against only 16% of the flies exposed to the powder-bearing surface of the second plate of the prior art. By weighing, it was found that the first plate had lost only 37.5% of its powder, while the second plate had lost 68.5% of its powder.

In a second experiment, the first plate 2 described above was charged with 0.09 grams of carnauba wax powder (again, a particle size of about 5 to about 20 micrometers in diameter) accommodated in and electrostatically bonded to the recesses 6. It was then placed in a horizontal position in the center of a standard fly testing room, 28 m² in area with plain white walls, floor, and ceiling with a hundred houseflies and left for five days. At the end of that period, all the flies were coated with powder to the extent of at least 500 powder particles per fly, the amount of powder removed from the plate 2 being approximately 0.01 grams, namely, approximately only 10% of the original amount.

In a third experiment, a concentrated jet of carbon dioxide gas from a pressurized cylinder was directed across the surface of each of the first and second plates for five seconds at a velocity of approximately one meter per second. Only 18% of the powder was removed from the recesses 6 of the first plate 2 of this invention, while 63% of the powder was removed from the smooth second plate of the prior art.

In a fourth experiment, the first plate 2 described above was charged with 1.0 grams of carnauba wax powder (particle size of about 5 to about 20 micrometers in diameter) accommodated in and electrostatically bonded to the recesses 6, and then placed horizontally in the bottom of a triangular monitoring trap in place of the normal sticky card. Three traps prepared in this way were then left suspended from trees outdoors in a garden at Southampton, England, for one week, during which time they were exposed to average early summer climatic conditions.

Three traps were similarly prepared but with the powder on a flat acetate sheet, to which the powder was initially adhered by electrostatic forces.

At the end of one week, an average of less than 1% by weight of the powder had been lost from the traps with the plate 2 of this invention, while an average of approximately 50% had been lost from the traps with the acetate sheet.

Thus, it will be appreciated that the invention enables the coating of pests, such as flying or crawling insect pests, with a pest-killing or behavior-modifying agent using a vector particulate material capable of being rendered airborne by the pests' own wing beats or other movements. Also, the loss of the particulate material, such as the powders 7 and 27 discussed above, from the inventive pest control trap, by wind or other air currents, is reduced, in some instances, considerably. Further, the loss of particulate material can be controlled by accommodating it in recesses associated with a surface of the inventive pest control trap. Moreover, flying insect pests in particular can be controlled by coating them with powder of other fine particulate material which can be electrostatically charged, for example by friction, as it is rendered airborne by the pests' movements. Such particulate material can incorporate biological, synthetic and/or natural pesticides and may also be rendered airborne by the pests traversing, by walking or running, the surface bearing that material, as described above in connection with the preferred embodiments.

What is claimed is:

1. A method of controlling a pest by at least partially coating the pest with particles of an electrostatically-chargeable particulate material incorporating a killing or behavior-modifying agent, the method comprising the steps of:
accommodating the particulate material within at least one region of a surface, at least some of the particles being electrostatically charged, at least some of the particles being more readily dislodged from the region by air flowing at the surface as compared to air flowing across the surface;
drawing the pest sufficiently close to the surface bearing the particulate material so as to render at least some of the particles airborne as a result of the airborne particles being dislodged from the region by air movement toward the surface resulting from wing beats of the pest while adjacent the surface, the air movement causing electrostatic charging of the airborne particles when dislodged from the region; and then
electrostatically coating at least part of the pest with the airborne particles.

2. The method according to claim 1, wherein the particulate material is combined with at least one biological, synthetic or natural pesticide as a killing agent.

3. The method according to claim 1, wherein the particles of the particulate material are sufficiently fine as to become airborne when the pest is an insect pest approximately the size of a housefly.

4. The method according to claim 3, wherein the particles of the particulate material have a size range of about 5 to about 100 micrometers in diameter.

5. The method according to claim 1, wherein the particles of the particulate material are formed of at least one material chosen from the group consisting of waxes, plastic polymers, ceramic materials, natural polymers, and cellulosic materials.

6. The method according to claim 1, wherein the surface is defined by an electrically insulating material.

7. The method according to claim 6, wherein the electrically insulating material is chosen from the group consisting of synthetic plastic polymers.

8. The method according to claim 6, wherein the electrically insulating material is formed as a layer on a biodegradable material.

9. The method according to claim 1, further comprising providing a pheromone or parapheromone attractant to lure the pest to the surface.

10. The method according to claim 1, wherein the particles are initially deposited in the region of the surface in an electrostatically-charged state and subsequently undergo electrostatic discharging to some degree.

11. The method according to claim 1 0, wherein the electrostatic discharging is predominantly through airborne moisture.

12. The method according to claim 1, wherein undesired removal or other loss of the particulate material from the surface is reduced by forming a raised edge at the periphery of the surface.

13. The method according to claim 1, wherein the region is formed as a recess in the surface, and the particulate material is more readily dislodged from the recess by air flowing at the surface and into the recess as compared to air flowing across the surface.

14. The method according to claim 13, wherein the recess is formed as a trough.

15. The method according to claim 13, wherein the recess has a maximum width of less than the body length of the pest.

16. The method according to claim 13, wherein the recess is formed to be substantially V-shaped in vertical section.

17. The method according to claim 13, wherein the recess is formed to have an upper periphery having a raised edge.

18. The method according to claim 1, wherein the particles of the particulate material are deposited to a thickness in excess of a monolayer so that a first plurality of the particles form a monolayer and directly electrostatically adhere to a surface of the region and a second plurality of the particles overlie the first plurality of the particles, are not directly electrostatically adhered to the surface of the region, and do not protrude out of the region and above the surface, the second plurality of the particles being more readily dislodged from the region than the first plurality of the particles and are more readily dislodged from the region by air flowing at the surface than by air flowing across the surface.

19. The method according to claim 18, wherein the particles within the region share a uniform charge of the same polarity and thereby repel each other.

20. The method according to claim 1, wherein the surface is part of a tubular trap and the surface is an interior surface of the trap.

21. A method of controlling a pest by at least partially coating the pest with particles of an electrostatically-chargeable particulate material incorporating a killing or behavior-modifying agent, the method comprising the steps of
depositing the particulate material within at least one recessed region of a surface, the particulate material being deposited to a thickness in excess of a monolayer so that a first plurality of the particles form a monolayer and directly electrostatically adhere to a recessed surface of the recessed region and a second plurality of the particles overlie the first plurality of the particles, are not directly electrostatically adhered to the recessed surface, and do not protrude out of the recessed region and above the surface so that the second plurality of the particles are therefore more readily dislodged from the recessed region than the first plurality of the particles and are more readily dislodged from the recessed region by air flowing at the surface than by air flowing across the surface,
drawing the pest sufficiently close to the surface bearing the particulate material so as to render airborne and electrostatically charge at least some of the second plurality of the particles by forces resulting from wing beats of the pest while adjacent the surface, and then
electrostatically coating at least part of the pest with the airborne and electrostatically charged particles.

22. A pest control apparatus comprising:
a surface to which a pest is capable of being lured, the surface having at least one recessed region;
particles of an electrostatically-chargeable particulate material that are contained in the recessed region and incorporate a killing or behavior-modifying agent, the particles being sufficiently fine to be rendered airborne and electrostatically charged by wing beats of an insect pest adjacent the surface, the particulate material being present within the recessed region to a thickness in excess of a monolayer so that a first plurality of the particles form a monolayer and directly electrostatically adhere to a recessed surface of the recessed region and a second plurality of the particles overlie the first plurality of the particles, are not directly electrostatically adhered to the recessed surface, and do not protrude out of the recessed region and above the surface so that the second plurality of the particles are more readily dislodged from the recessed region than the first plurality of the particles and are more readily dislodged from the recessed region by air flowing at the surface than by air flowing across the surface.

23. The pest control apparatus according to claim 22, wherein the particulate material is combined with at least one biological, synthetic or natural pesticide as a killing agent.

24. The pest control apparatus according to claim 22, wherein the particles of the particulate material are sufficiently fine as to become airborne when the pest is an insect pest approximately the size of a housefly.

25. The pest control apparatus according to claim 22, wherein the particles of the particulate material have a size range of about 5 to about 100 micrometers in diameter.

26. The pest control apparatus according to claim 22, wherein the particles of the particulate material are formed of at least one material chosen from the group consisting of waxes, plastic polymers, ceramic materials, natural polymers, and cellulosic materials.

27. The pest control apparatus according to claim 22, wherein the recessed surface is defined by an electrically insulating material.

28. The pest control apparatus according to claim 27, wherein the electrically insulating material is chosen from the group consisting of synthetic plastic polymers.

29. The pest control apparatus according to claim 27, wherein the electrically insulating material is a layer on a biodegradable material.

30. The pest control apparatus according to claim 22, further comprising a pheromone or parapheromone attractant on the apparatus so as to lure the pest to the surface.

31. The pest control apparatus according to claim 22, wherein all of the particles of the particulate material are electrostatically charged, share a uniform charge of the same polarity, and thereby repel each other.

32. The pest control apparatus according to claim 22, wherein the particulate material is more readily dislodged from the recessed region by air flowing at the surface and into the recessed region as compared to air flowing across the surface.

33. The pest control apparatus according to claim 22, wherein the upper periphery of the recessed region has raised edges.

34. The pest control apparatus according to claim 22, wherein the recessed region has a maximum width of less than the body length of the pest.

35. The pest control apparatus according to claim 22, wherein the recessed region is substantially V-shaped in vertical section.

36. The pest control apparatus according to claim 22, wherein the surface is part of a tubular trap and the surface is an interior surface of the trap.
